(19) United States
(12) Patent Application Publication
(10) Pub. No.: US 2005/0182702 A1
(43) Pub. Date: Aug. 18, 2005

(54) Systems and methods for implementing an interest-bearing instrument

(76) Inventor: Roger Howard Williams III, New York, NY (US)

Correspondence Address: LADAS & PARRY, 26 WEST 61ST STREET, NEW YORK, NY, 10023, US

(21) Appl. No.: 10/777,586

(22) Filed: Feb. 12, 2004

(51) Int. Cl. G06F 17/60

(52) U.S. Cl. 705/35; 705/37; 705/38

(57) ABSTRACT

Systems and methods are provided that allow a financial instrument to be structured so that the underlying borrowed principal is callable, putable, or both. In a preferred embodiment, a Range Accrual Mortgage is structured so that the underlying borrowed principal is a mortgage that is callable, putable, or both by embedding into the loan structure a rate put option. Systems and methods according to the invention lend symmetry to the interest rate behavior of certain borrowings by making explicit the pricing and market value of options that were previously only implicit in the borrowing structure. For example, a mortgage in accordance with the invention should provide incentives for either the homeowner or the bank to refinance the mortgage and should do so whether interest rates rise or fall, and no matter what path interest rates follow from the inception of the instrument until the maturity of the instrument. The invention achieves the desired advantages, in part, by extending the characteristics of a borrowing via the addition of a rate put option on an interest rate and, in part, by permitting correlative adjustments to the outstanding loan principal.

### BACKGROUND OF THE INVENTION

Under current market practice, some interest-bearing instruments generate asymmetric price changes in response to interest rate changes. For example, there would be a financial incentive for a homeowner to refinance a mortgage were the market interest rate for mortgages to fall: upon refinancing, the homeowner's monthly payments would be adjusted downward. However, there would be no financial incentive for the homeowner to refinance a mortgage were the market interest rate for mortgages to rise.

In part, this asymmetric behavior is driven by current market pricing and structuring conventions under which some implicit embedded options in borrowing instruments are recognized and priced, while other implicit embedded options are either not considered, not priced, or not priced properly.

It is well known that certain interest-bearing instruments are difficult to construct, price, and hedge. For example, the pricing response of mortgage-backed securities (“MBS”) is known to reflect both economic and non-economic market factors. (As used herein, “MBS” may refer to one or more mortgaged-backed securities.) Economic factors that affect pricing may include, among other things: the right to buy the underlying debt obligations back from the creditor; the historical interest rate at the inception of the underlying obligations; the current market interest rate for substantially similar obligations; the debtor's degree of indebtedness; and the value of the underlying collateral (if any). Non-economic factors that affect pricing may include, among other things: the debtor's consumption preferences for the intrinsic value of the housing received at spot (i.e., current market interest rate) through the borrowing of money versus the value of the money to be foregone at a later time via interest and principal repayments.

In particular, the price/yield response of MBS or other similar collateralized instruments may reflect embedded and implicit call options within the collateral underlying the MBS. These call options allow the debtor (such as a homeowner) to buy the underlying loan back from the creditor (such as a bank). Because debtors are allowed to repay the face value of the outstanding balance of the underlying borrowing at par at any time prior to the nominal maturity, MBS, from the investor's perspective, are subject to prepayment or contraction risk (shortening of nominal tenor). Market participants recognize that the debtor's ability to repay the underlying borrowing at any time is impliedly equivalent to the debtor being long a call option to buy back the outstanding face value (i.e., the remaining book value) of the borrowing at any time, while the creditor is understood to be, impliedly, short that same call option.

In consequence, in a declining interest rate environment, the owner of an MBS (which bundles callable loans together into one security) may have the tenor of his MBS shorten dramatically. If the tenor of his investment shortens because the underlying collateral is called away, the MBS investor must reinvest his funds at lower rates of interest. Because the MBS investor is not protected against falling rates, the MBS investor does not have the protection afforded by an interest rate floor (“IRF”). An IRF is typically struck at a level, “X”, to insure against revenue losses that would be generated by interest rates dropping below X. If interest rates drop, the owner of the IRF option will collect, approximately, the present value of the difference between the strike rate X and the new lower interest rate multiplied by the notional amount of the IRF. Thus, declining interest rates generate losses for any investor who is not long an IRF. To phrase the matter in the inverse sense, any investor not long an IRF is, impliedly, short an IRF and thus unprotected in the event of interest rate declines; any investor in a callable security is short an IRF and, in consequence, experiences revenue losses generated by declining interest rates.

The MBS investor's implied short IRF is equivalent to a short (impliedly sold to the debtor on the underlying collateral) one-touch or barrier knock-out option struck at the original contract rate: when rates drift or diffuse or jump below the original contract rate (touch or pass through or transit the barrier), the MBS investor's option on the MBS yield (at the original contract level) is knocked out or negated when homeowners exercise their long call on the underlying collateral. When that implied short IRF option knocks out, the MBS investor experiences tenor contraction risk, and is free to reissue securities at the lower market level; but, in consequence, earns a lower rate of return on his new investments.

Because the existence of the implicit call option is generally accepted, market pricing dynamics explicitly calculate the value of MBS instruments (constructed from underlying instruments, generally residential mortgages or whole loans) inclusive of the call option, even though those securities only implicitly carry this callability. It is well understood that lower levels of market interest rates will provide the underlying debtors with an incentive to buy back and to refinance their borrowings, whereas higher market interest rates will usually create a disincentive for the underlying debtors, absent non-economic (“irrational”) reasons, to buy back and refinance the borrowings or loans at uneconomic (higher) interest rates.

It would be advantageous to provide systems and methods that would permit taking the market pricing convention (inclusive of the implicit call option) currently used and extending that pricing methodology to include other aspects of the underlying instrument's embedded, implied optionality in order to allow an instrument to be retired, in whole or in part, or extended in tenor, in whole or in part, and/or adjusted as to rate, in whole or in part.

Additionally, it would be advantageous to improve current interest-bearing instruments—and indeed the pricing of all market loan instruments—by moving them closer to full compliance with the hoped-for parity equivalence expected of arbitrage-free markets. While not arbitrage-free, such improved instruments would represent a more efficient trading vehicle for consumers, hedgers, and speculators in interest-rate markets, no matter what the nature of the instrument, and whether or not the product is attached to a related or underlying aggregation of collateral.

It would further be advantageous to create or manufacture an interest-bearing instrument such that, no matter what the level of current interest rates relative to the interest rate levels at the time of original instrument issuance, the instrument more accurately reflects the value to the debtor and the creditor of taking a “view” relative to: 1) the current/spot expected term structure of forward interest rates (spot-forwards); and/or 2) the expected forward evolution of the forward term structure of interest rates (forward-forwards). Such forward “views” should reflect the expected probabilities of: rate neutrality, rate decreases, and rate increases.

### SUMMARY OF THE INVENTION

The present invention allows a financial instrument to be structured so that the underlying borrowed principal is callable, putable, or both. In a preferred embodiment, a Range Accrual Mortgage (“RAM”) is structured so that the underlying borrowed principal is a mortgage that is callable, putable, or both by embedding into the loan structure a rate put option (“RPO”). Preferably, this is accomplished via the following steps:
A) If the average forward-forward rate, from the time of the RPO valuation, through the remaining nominal term of the contract, is greater than the original (time zero) contract rate, then
B) set the new contract rate equal to that average forward-forward rate, net of, if such a charge is called for under the RAM variant being analyzed, an adjustment for the annuitized value of the RPO; and
C) set the loan adjustment, subsequent to the RPO exercise, equal to the difference between:
   1) the present value of the remaining initial mortgage cash flows present-valued at the average of the forward-forward rates; and
   2) the present value of the remaining initial mortgage cash flows present-valued at the initial contract rate which was set at time zero.

This invention lends symmetry to the interest rate behavior of certain borrowings by making explicit the pricing and market value of options that were previously only implicit in the borrowing structure. For example, a mortgage in accordance with the invention should provide incentives for either the homeowner or the bank to refinance the mortgage and should do so whether interest rates rise or fall, and no matter what path interest rates follow from the inception of the instrument until the maturity of the instrument. The invention achieves the desired advantages, in part, by extending the characteristics of a borrowing via the addition of a rate put option on an interest rate and, in part, by permitting correlative adjustments to the outstanding loan principal.

The invention permits a hitherto unquantified aspect of price behavior—the embedded RPO and its consequent sensitivity to a changing interest rate regime—to be made explicit, quantified, and used to correctly price instruments formerly deficient in this regard. This change in embedded optionality is linked directly and causally to fluctuations of the underlying borrowed principal in response to fluctuations in market interest rates.

The invention provides systems and methods for implementing a structured financial instrument that augments the allowable set or trading set of interest-bearing instruments. In other words, the invention augments the function-space (i.e., the set of functions used for calculations) within which the value of interest-bearing instruments is calculated. In the most generalized context, the creditor conveys value to the debtor at one point in time (“spot”), and is repaid a value at a later point in time (“forward”). The time difference between spot and forward may, if necessary for mathematical or computational purposes, be considered to approach zero, or be “instantaneous.” Further, while the unit of value conveyed may be in units of some national (sovereign) or notional currency (change of numeraire), the units of exchange or trade may be in any form that stores value during the time that will elapse between the spot and forward dates. The values conveyed may, or may not, be securitized or collateralized by other units of either spot or forward value.

The invention further provides systems and methods for structuring an interest-bearing instrument, the pricing of which is not fully or correctly market-based, so that it becomes more fully market-based. This invention prices interest-bearing borrowings with consistency, under a parity construct, relative to other such instruments. Pricing under conditions of parity will not ensure arbitrage-free pricing, but will ensure that instruments that share a common underlying function-space are priced consistently relative to each other. This invention also permits hitherto unrecognized, implicit options to be identified and made explicit (if such treatment is desirable), and appropriately prices those instruments in the context of the implied parity between: underlying instruments; options and other options; options and cash; or any combination of the foregoing.

The invention further provides both the structure of the enhanced optionality embedded in the contemplated borrowing structure (including the trade-offs formed between the new and enhanced embedded options) and the enhanced underlying cash flows of the related borrowings. Numerous other advantages will be apparent to those of skill in the art.

In a preferred embodiment of the invention, an interest-bearing instrument in the form of a borrowing is created that may be offered in one or more of the markets where spot and forward value are exchanged. The instrument offered is unconstrained regarding whether or not the rate of interest paid/received represents a “fixed” or “floating” rate of interest at inception, and whether or not the instrument contains embedded within it options sold to or purchased from either or both the debtor and the creditor. The embedded options offer to either or both parties the ability to change the terms of the exchange of values during the nominal tenor or nominal life of the aggregate instrument or instrument package.

In another preferred embodiment, a method for enabling market-based pricing of a financial instrument comprises the steps of:
(a) a debtor selling to a creditor an instrument evidencing borrowing of a principal;
(b) the creditor selling to the debtor a call option to repay the principal, or a portion thereof, early relative to the original maturity;
(c) the debtor selling to the creditor a rate put option (RPO);
(d) the debtor receiving the value of the RPO as well as the right, if market-interest rates have changed and the debtor's call option has been exercised, to have the debtor's principal adjusted to reflect the debtor's absorption of new market-interest rates (i.e., spot-forward and/or forward-forward interest rates);
(e) the debtor paying an initial stated level of interest to the creditor (the interest, whether paid or received, may be quoted or stated with any compounding convention);
(f) the creditor giving the debtor the option to retire any amount of the principal at any time;
(g) the debtor selling to the creditor the right for the creditor to cause the debtor to pay, in the future, an interest rate that is different from the interest rate payable at the instrument's inception; and
(h) if the creditor exercises the right to cause the debtor to pay a different interest rate than that originally contracted for, the debtor receiving an adjustment to the principal.

In other preferred embodiments, computer-based systems are used to enable market-based pricing of a financial instrument in accordance with the invention.

### BRIEF DESCRIPTION OF THE DRAWINGS

FIG. 1 is a flowchart of software that may be used in a system for providing a RAM product according to the present invention.

### DETAILED DESCRIPTION OF THE PREFERRED EMBODIMENTS

Considered mathematically, the right to buy an interest-bearing instrument allows the creditor to require of the debtor repayments of principal and interest that may equate to the payment of, in the aggregate: positive interest, zero interest, or negative interest. While the zero and negative interest cases are uncommon, they do occur in the market and will be considered for the sake of completeness. Currently, interest-bearing instruments—including, for example, residential and commercial mortgages and automobile loans—may reflect the conventional right to retire the borrowing using the implied embedded call option:
as interest rates decline, the value of instruments that are priced inversely thereby tend to rise, and tend to be positively convex in the price/yield range that is outside of the range of rates under which the call option might (most probabilistically) be exercised; and
inside of the range of rates that includes the highest probability of option exercise, the price/yield relationship of those instruments may be adjusted by the value of the implied embedded call option and may tend to become negatively convex.

The present invention uses an implicit right granted to the debtor to sell a put on the interest rate—a rate put option (“RPO”)—to the creditor in order to change the price/yield relationship of the instrument relative to the price/yield behavior evinced by existing instruments. A key preferred embodiment of the invention is a new mortgage structure. That structure is called a range accrual mortgage (“RAM”), which has embedded within it a rate put option. The RAM is further defined below.

An RPO, by contractual agreement between debtor and creditor, is an option that may be exercised upon one or more types of interest rate (or asset that proxy or index one or more of the rates selected). The RPO, which the debtor sells to the creditor, gives the creditor the right to require of the debtor (subject to the condition that the RPO is exercised, as that term in understood by those skilled in the art) that the initial contract-interest-rate level at time-zero be replaced by the strike-interest-rate level embedded in the RPO. By agreement, this event will occur when the strike-interest-rate level is less than or equal to a selected index. Also by agreement, the strike-interest-rate level will use an underlying reference index.

The underlying index may be, but is not limited to: 1) a spot interest rate; 2) a spot-forward interest rate; 3) a forward-forward interest rate; 4) the projected evolution of a term-structure of interest rates; or any combination of the foregoing items #1-3. The description of the preferred embodiments below may refer to one or more of the foregoing types of interest rate underlying the RPO, as dictated by the specific context. However, those skilled in the art will realize that these are preferred embodiments only and that the nature of the underlying interest rate may take practically an infinite number of forms. Thus, in any given context the nature of the interest rate used below should be considered illustrative, and thus neither exhaustive nor definitive.

For any implicitly or explicitly callable interest-bearing instrument, under standard concepts of parity, because the debtor may own an unexercised call on the instrument, the debtor is implicitly long a complementary put on the rate (an RPO): as rates rise and outstanding bonds become less valuable, by choosing not to call the instrument back (which would allow the creditor the opportunity to force the debtor to issue a new, higher-interest-rate instrument), the debtor can force the creditor to remain long (i.e., earn) a below-market interest rate. The debtor is thereby allowed implicitly, to put a below-market rate to the creditor, and should be able to explicitly price and sell this RPO to the creditor if the debtor wishes to do so.

For example, when the interest-bearing instrument is a mortgage, because the homeowner implicitly owns an unexercised call option on the mortgage, he implicitly owns a complementary put option on the interest rate (an RPO): as rates rise and outstanding mortgages become less valuable to the bank, by choosing not to call the mortgage back (which would allow the bank to issue a new, higher-interest-rate mortgage), the homeowner can force the bank to retain ownership of a below-market interest rate instrument. The homeowner owns an RPO, and should be able to sell this RPO to the bank if he wishes. Such a mortgage in accordance with the present invention is called a Range Accrual Mortgage (RAM). The present invention imputes value to this RPO and provides an incentive to a debtor (such as a homeowner), through the initial contracting process, to sell that RPO to a creditor (such as a bank). Since the debtor is long the RPO, the creditor is short; if the debtor is long an option, the debtor may be able to negotiate with or contract with the creditor to have the creditor buy the RPO from the debtor.

In a preferred embodiment, the implicit RPO is made explicit via a sale by the debtor to the creditor of a put on the current and forward levels of interest rates. Sale of the RPO by the debtor to the creditor may be monetized or implemented via one of several methods: 1) an adjustment to the debtor's loan rate; 2) an adjustment of the debtor's loan principal; or 3) a combination of rate adjustment and loan adjustment.

If only the debtor's loan principal is adjusted, such an adjustment would: 1) create equity for the debtor through a borrowing reduction; 2) reduce the probability of debtor default; 3) allow the creditor to reduce his balance-sheet exposure to underwater borrowings (i.e., loans issued at historical contract rates below current and/or expected forward rates) as interests rise; and 4) eliminate creditor extension risk as to both the underlying collateral, and as to any MBS instruments constructed thereon.

If only the debtor's loan rate is adjusted, such an adjustment would:1) provide the debtor with income increase (or expense reduction); and 2) reduce the debtor's forward probability of defaulting due to a forward absorption of an unmanageable increase in forward payments due to increased interest rates.

An interest-bearing instrument may be defined using the below notation and formulae:

| Symbol | Definition |
|---|---|
| V | Value of loan at some time “t” |
| L | Loan Principal at some time “t” |
| CF | Cash-Flow: a) may be single flow or aggregate of flows |
| | occurring at various times “t”; b) may be spot or forward |
| | dollars; c) may be principal, or interest, or both; |
| R_{f} | Forward Rate: may or may not be inclusive of time |
| | scalar |
| Rₖ | Contract Rate: may or may not be inclusive of time |
| | scalar |
| “t” | A given time which may be: time-zero, maturity, any |
| | time in between time-zero and maturity |
| T | The time of nominal maturity: for an individual cash |
| | flow, or for the instrument in its entirety |
| $\begin{matrix}A \to B OR \\ A ← B\end{matrix}$ | A implies B; or B implies A; or an assignment statement resulting from a computation |
| * | Operation of multiplication |
| ${\sum }_{i = *}^{i = *}$ | Operation of summation |
| (#)⁻ⁱ | Operation of exponentiation where “#” is an argument |
| “A\|B” | Given, or conditional on the occurrence of “B”, then assume that “A” occurs or exists. |

### The Generic Loan Calculation

A generic fixed-rate loan, which is neither callable nor putable, is typically re-valued so that the value to the debtor at some time “t” is equal to:

$${V}_{t} = {\sum }_{i = 1}^{i = T} - {CF}_{i} * {( 1 + {R}_{{k}_{0}} )}^{- i} \qquad ( 0 )$$

Stated in words, the value of a non-callable and non-putable loan at any time “t” is determined with reference to: 1) a remaining Cash Flow (CF) or collection of Cash Flows (CF); 2) a deterministic interest rate (i.e., fixed contractually, and therefore known with complete certainty, at time-zero); and 3) a time period over which interest is to be calculated (the time scalar is embedded in Rₖ_{₀} for each time period considered).

The principal to be repaid and periodic interest are both computed (both of which are, without differentiation or distinction, represented by −CF_{remaining}), then present-valued to time “t”. A fixed rate mortgage loan is simply a bundle of these agreements (i.e., —CF_{remaining} is composed of a number of cash flows, as indicated by the sigma notation, not just one cash flow), whereby the creditor loans a lump sum to the debtor and the debtor pays back the principal plus interest (P&I) monthly with a sequence of cash flows.

Mortgages exhibit a small computational wrinkle in that interest is front-loaded, and principal repayment is back-loaded. Notwithstanding the market convention that mandates the back-loaded repayment of principal, principal is always stated in spot dollars and as a remaining notional amount or percentage of the original face amount of indebtedness. The exponential discount factor used above in equation (0) is assumed to be derived from the spot discount factor applied to either: 1) a risk-neutral zero coupon bond maturing at the same time as the maturity of the cash flow that is to be discounted (viz., “t=T” for both the given cash flow and its related discount factor), or 2) a risky zero coupon bond maturing at the same time as the maturity of the cash flow that is to be discounted (viz., “t=T” for both the given cash flow and its related discount factor). The nature of the zero-coupon bond discount factor to be used must be determined in the context of the credit-risk imposed upon the creditor by his acceptance of the underlying credit profile of the debtor.

### The Fixed-Rate Mortgage Loan Calculation: Rising Rate Environment

Mortgage loans, by market convention, are typically underwritten in such a fashion that the implied relationship below holds:

$${V}_{t} = {\sum }_{i = 1}^{i = T} - {CF}_{i} * {( 1 + min ( {R}_{{k}_{0}} , {\overline{R}}_{{f}_{t}} ) )}^{- i} \qquad ( 1 )$$

Where, in a standard or conventional mortgage loan not subject to a mark-to-market process, [\overline{R}_{f}_{ₜ}>Rₖ_{₀}]→[Rₖ_{₀}]: that is, impliedly, if the average forward rate is greater than the contract rate at inception, then, set the rate to be used for both accruals (embedded in “−CF” via the initial contract) and discounting equal to the initial contract rate. Therefore, in the rising rate state of the world, equation (1) for a standard mortgage uses the initial contract rate and ignores the average forward-forward rate (computed at any time “t”) when the average forward-forward rate is greater than the contract rate. That is, neither the accrual rate nor the discounting rate will be adjusted to reflect rates that are greater than the initial rate(s) contracted for

Further, in a standard or conventional mortgage loan, Loan Size, represented by “—CF” above in equations (0) and (1) and by “L” below in equation (2), is conditional at each moment in time on a comparison between the initial contract rate and the average of forward-forward rates:
[L_{remaining}=L_{remaining}|\overline{R}_{f}>Rₖ] (2)

Stated in words, conditional on the average forward-forward rate being greater than the initial contract rate, the remaining loan principal will not be adjusted.

### The Fixed-Rate Mortgage Loan Calculation: Falling Rate Environment

However, if the average forward-forward rate is below the contract rate, [\overline{R}_{f}_{ₜ}, <Rₖ_{₀}], equation (1) is conditional on a comparison between the contract rate at inception versus the market rate at any time “t” in that the cash flows represented by the old loan are set equal to zero:
[L_{old}=0|Rₖ>\overline{R}_{f}] (3)

Stated in words, the old loan value, impliedly, is allowed to go to zero conditional on the original rate embedded in the contract being greater than the average of the forward-forward rates. Under the conditional equation (3), equation (1) is still used for revaluations, but the factor represented by −CF is reset to zero pending refinancing. Then the refinancing is done by issuing a new mortgage, and the quantity −CF is reset equal to the remaining level of indebtedness carried over from the initial mortgage, and the new interest rate is fixed equal to a market rate of interest [\overline{R}_{f}_{ₜ}<Rₖ_{₀}]→[\overline{R}_{f}_{ₜ}] for both accruals and discounting.

### The Mortgage Loan Calculation: Results for Creditor and Debtor

Under these implied relationships, forward-forward rates evolve in a nondeterministic fashion (i.e., one does not know, at spot, what forward-forward rates will be) such rates may be equal to, greater than, or less than either the spot rate or the spot-forward rates. Further, because they are uneconomic to the debtor, it is assumed that forward-forward rates greater than the initial contracting rate are considered (for calculational purposes) to constitute the maximum of the set Max {R_{f}, Rₖ}. Thus equation (1) is interpreted such that the forward rate is ignored (because using the minimum is equationally required) and the initial contract rate, as the minimum of the set, is used for both accruals and discounting. That is, when rates rise: 1) the contract rate is fixed, and is not changed to reflect higher accruals; and 2) because mortgages are typically not marked-to-market, the higher rate for discounting forward flows is not used.

Conversely, if the initial contract rate is above the average forward rate at a forward time not equal to zero (i.e., the date of the original contract initiation), then the contract will be voided, and the initial loan amount will go to zero under the conditional equation (3); simultaneously, a new loan will be written at the average then-current contract rate, which will be assumed to be the average of the expected forward-forward rates.

As a result of the conjunction of equation (1) and the related conditional statements concerning the average forward rate, rising rates are punitive to the creditor, while falling rates benefit the debtor.

### The Mortgage Loan Calculation: The RAM (One Embodiment)

The below conditional statement is inherent in the standard mortgage structure:
[L_{old}=0|Rₖ>\overline{R}_{f}] (4)

In a preferred embodiment, a RAM in accordance with the invention recognizes, first, that equation (4) implies that the loan value specified in equation (5) below is callable (i.e., not marked to market) in a context of declining rates, and that neither the accrual nor the discounting rates are constants:

$${V}_{t} = {\sum }_{i = 1}^{i = T} - {CF}_{i} * {( 1 + min ( {R}_{{k}_{0}} , {\overline{R}}_{{f}_{t}} ) )}^{i} \qquad ( 5 )$$

Because the loan underlying a standard mortgage is impliedly callable at the borrower's option, the rate used for both accruals and discounting should be the minimum of the set below when the average forward-forward rate drops below the contract rate:
min{\overline{R}_{f}_{ₜ}, Rₖ}=\overline{R}_{f}_{ₜ}, |[\overline{R}_{f}_{ₜ}<Rₖ_{₀}] (6)

Additionally or correlatively, the RAM recognizes that, according to equation (2), the second conditional:
[L_{remaining}=L_{remaining}|\overline{R}_{f}>Rₖ] (2)
implies that the loan is, but should not be, a constant whenever average forward-forward rates exceed historical contract rates, and recognizes that this second conditional creates an asymmetry in the mortgage market: typically, borrowers do not ask to pay a higher loan rate when rates increase. Exercising into a higher loan rate is typically done for un-economic reasons (e.g., bankruptcy, mandatory sale, or relocation), and is typically described as “irrational exercise” in that it decreases the debtor's wealth by: a) absorption of refinancing costs; or b) absorption of higher monthly payments through absorption of higher interest rates.

In sum, the classical fixed-rate mortgage looks less like a loan, and more like a bundle of callable forward rate agreements that, by virtue of their callability in a declining rate environment only, create an asymmetry between debtor and creditor. A RAM attempts to bring symmetry to the market by adding putability to the standard loan contract. The interest rate, in some variants of the invention (e.g., a double-barrier RAM variant), may be allowed to conditionally float within a range specified by the contracting parties. In one preferred form of the invention, the rate does not float automatically as does a variable rate mortgage (i.e., it is not an obligation, as is imposed by a forward rate agreement); rather, the rate floats at the whim of the debtor (optionally, and when rates drop) and at the whim of the creditor (optionally, and when rates rise).

Note that traditional variable rate mortgages, in contradistinction to the RAM, create several hidden and mandatory—not optional—jeopardies in a rising rate environment:
if rates are quite volatile, the lifetime cap on the rate may be invoked after a rapid rate rise, and the variable rate may convert to a very high and very punitive (to the debtor) fixed rate;
a rate that is punitive to the debtor, may become punitive to the creditor as well, if the debtor is forced into default thereby;
before capping at a fixed rate, the increasingly higher rates under a variable rate structure may lead to negative amortization, or increases in the underlying loan principal; such a process is equivalent to the debtor, without even realizing it, having sold at contract inception an additional loan-principal-put (not a rate put or RPO) to the creditor above and beyond his initial loan amount; in other words, “L” may become “L+A” where “A” is an additional loan amount not originally forecasted or bargained for by the debtor at loan inception; and
rate increases under a standard variable rate product, unlike under the RAM product, are:
not readily subject to the debtor's control (mandatory action, not optional action); and
may not adequately compensate the debtor for absorbing the additional probabilistic danger of rate increases (are not fairly priced from the perspective of the debtor).

### The Variable-Rate Mortgage Loan Calculation: A Comparison

It is useful to understand the present invention by considering a conventional variable-rate mortgage, which may be analogized to the below relationship:

$${L}_{{t}_{0}} = {\sum }_{i , f , k , t} - {CF}_{i} * ( {R}_{{k}_{0}} + ( {R}_{{f}_{t}} - {R}_{{k}_{0}} ) ) * {( 1 + {R}_{{f}_{t}} )}^{- i} \qquad ( 7 )$$

Note that equation (7), because it includes a contract rate and a market rate, looks like a bundle of forward rate agreements that, when revalued via the spread difference between the contract rate and any forward rate, may create either an additional asset or a liability for either party above and beyond what was originally contracted for (c.f., “L+A” described above):
A) if, in (7), R_{f}=Rₖ the market interest rate charged to debtor, though variable, appears to be “fixed”;
B) if, in (7), R_{f}>Rₖ, then the debtor will pay the initial contract rate plus a positive spread; and
C) if, in (7), R_{f}<Rₖ, then the debtor will pay the initial contract rate plus a negative spread;

Thus a variable rate mortgage is a pure, and contractually mandatory, speculation on rates. As such, the equation (7) looks like a variable rate mortgage: rising rates punish the debtor and falling rates punish the creditor. But the above structure does not take into account either the callability or potability of rates. As such, the characteristics of a standard mortgage, whether fixed-rate, with the above conditionals (as in equations (0)-(3)), or floating-rate (equation (7)) are structurally deficient as to the measurement and timing of the value of the rate movements (expressed as either a call or put option delta), which would be embedded into the principal adjustment under a RAM structure in accordance with the invention.

Further, if it were the convention in a standard mortgage that a mark to market process be used, such a process would be a one-time event with implications for retaining or terminating the original contract. In contrast, an embedded option structure does not, or may not, require exercise of those embedded options. Options, which are not exercised, continue to provide an ongoing insurance value to the long holder. Thus, options can afford the option owner a mode of decision making (as to timing) that an arbitrary mark-to-market process does not.

It should be noted that a RAM according to the instant invention creates a direct correlation between option exercise and interest rates. A simple mark-to-market product (e.g., a fixed-rate mortgage, or a variable rate mortgage where the debtor does not optionally control the level of interest paid, or the outstanding principal owed, or the remaining tenor) may require the debtor to: 1) pay a higher monthly payment; 2) provide more equity (in the form of cash); 3) assume a larger level of indebtedness; or 4) accept a different interest rate at an inopportune time. In consequence, a variable-rate mortgage revaluation for a mark-to-market product must be artificially and directly correlated with debtor liquidity or the debtor's credit rating at the time of revaluation. Likewise, for a variable-rate mortgage, periodic caps may either: a) mitigate the yearly increase in interest, which must be paid due to rising rates, or; b) mitigate the amount of negative amortization experienced, but the changes of the accrual and discounting rates and the changes to the amortization are not linked via a joint valuation process and are not reflected back as a reductive adjustment to the loan principal, as under the RAM.

It should also be noted that, unlike the RAM, other products may also require that the debtor make a decision between two portfolios: 1) being long a consumption portfolio (owning a house, car, boat, etc.); or 2) being long a larger amount of cash, but short the consumption item (house, car, boat, etc.).

### The Ram: Other Preferred Aspects

By allowing liquidity and consumption decisions to be decorrelated relative to individual investor preference, various embodiments of the RAM product may beneficially reduce decision making relative to: 1) decisions as to how much spot and forward interest rate risk to absorb; 2) how or when to upgrade the debtor's credit standing via the correlative principal adjustment; 3) how or when to monetize increases in debtor equity.

Thus a conventional mortgage structure is deficient in that it does not measure debtor preference, and also does not compensate debtor preference. By contrast, under standard arguments of risk neutrality, the RAM does not need to measure debtor preference in that it fairly compensates for rate changes. Nevertheless variants of a RAM that will be apparent to skilled artisans would allow debtors to express preferences under conditions other than under risk-neutrality rather than simply waiting for an optimal exercise opportunity under, assumedly, conditions of risk-neutrality.

A RAM is structured so that the underlying mortgage may be either callable, or putable, or both. In a preferred embodiment, an RPO is embedded into the structure, via the below steps A)-C), such that an appropriate charge for the RPO may be assessed against the then current market rate (if the RPO value is annuitized under the particular structure):
IF: \overline{R}_{f}_{_{t→t+n}}>Rₖ_{₀}_{→}

Stated in words, if the average forward-forward rate is above the original contract rate, then follow steps A), B) and C);
A) Set Rₖ_{_{new}}=\overline{R}_{f}_{_{t→t+n}}

Stated in words, the new contract rate for the remaining nominal contract tenor is set equal to that average forward-forward rate (a significant and conditional change to equation (1) that exists under the standard mortgage).

In addition to step A) above, in step B), adjust the outstanding loan principal using equation (8) below:

$$B ) {L}_{adjust} = {\sum }_{i = t}^{i = t + n} - {CF}_{i} * [ {( 1 + {R}_{{k}_{new}} )}^{- i} - {( 1 + {R}_{{k}_{0}} )}^{- i} ] \qquad ( 8 )$$

Stated in words, set the loan principal adjustment equal to the difference between principal and interest (described, without distinction/differentiation, as cash flows or as −CF) discounted at the new average forward-forward rate, versus the principal and interest discounted at the original contract rate.

In step C), use equation (9) to revalue the loan using both the new rates set in step (A), as well as the loan adjustment from step B), where step B) takes step A) as an input:
C) Vₜ=L_{old}+L_{adjust} (9)

Stated in words, the value of the loan at any time “t” is equal to the value of the old loan plus a loan adjustment.

In one preferred embodiment of the invention, the above three steps accomplish the following:
1) an RPO, sold at inception to the creditor by the debtor, is exercised;
2) as a result of the RPO exercise, a new contract rate is struck between the creditor and debtor at the exercise or strike rate specified in the initial contract;
3) the debtor and creditor agree to:
   a) reset the loan interest rate to the RPO strike rate; and
   b) discount the remaining originally calculated cashflows at the new discount rate determined by the strike rate of the RPO;
4) the remaining balance of the loan is calculated such that:
   a) the monthly payment on the new loan is equal to the monthly payment on the original loan; and
   b) the new loan principal is equal to the present value (at the new rate) of the remaining-originally-contracted monthly cashflows; in the alternative,
   c) the loan principal adjustments may be greater than, equal to, or less than the original book value;
   d) the loan principal adjustments may or may not equate to an exact mark-to-market based upon current market rates (evolution of the forward-forward term structure or contractual terms may move the mark away from market);
5) the value of the RPO that is sold by the debtor to the creditor may be paid for by the creditor making an adjustment to:
   a) loan principal; and/or
   b) the contract rate; and/or
   c) the monthly scheduled payments.
   d) In some of the cases above, the sale of the RPO may have the practical implication of reducing the creditor's original short call option position;
   e) In all of the cases above, the loan adjustment is more sophisticated than a simple mark-to-market (“MTM”) of the spread-value between the original contract rate and the exercise rate: the loan adjustment is linked to the expected evolution of the forward-forward term structure, as well as the delta structure embedded in the totality of options embedded in the RAM;
   f) The dynamic re-pricing of the principal indebtedness which is provided by the embedded optionality will reduce the need, in many cases, for refinancing; in such instances, the RAM will lead to significantly lower transaction costs, while offering many benefits;
   g) Benefits to dynamic re-pricing:
      i) Either a voided initial contract (based upon an interest rate drop), or an MTM might imply transaction costs (i.e., the need to re-close the loan consequent to a rate drop; the need to MTM the loan as rates rise might imply re-closing or a transfer of cash);
      ii) To the extent that the RAM impounds benefits via the option valuation, and to the extent that the contracting parties agree that wealth transfers can be observed, measured and recorded without a new document, and to the extent parties agree not to exercise but to retain the insurance value impounded in a live (unexercised) option, transaction costs will be saved;
   h) Because the rate payment increase required of the debtor is, in one preferred variant, exactly offset by the reduction in loan principal, there should be no tax consequences to the transaction at spot (though there may be forward timing differences);
      i) Forward income timing differences generated by the option revaluation process may be created by any differences that occur between forward-forwards (as calculated at spot), and forward-forwards as they roll into spot at future times and are realized through the transfer of cash or other value. However, such timing differences occur in any contract revaluation that is revalued via the forward rate or forward price market; and
   j) Unlike a variable rate loan, acceptance of a higher rate, when offset by principal reduction, does not lead to any of the bad consequences associated with a variable rate loan: 1) a higher monthly payment; 2) negative amortization; 3) the potential “fixing” of a punitively high fixed rate for the remainder of the loan term; 4) a combination of the foregoing.

Note that rising rates under the RAM structure reduce the value of the MBS investor's implicit short call option on the underlying indebtedness or collateral, and increase the value of an RPO. Note also that the RAM imputes a rational value to both the RPO pricing and the RPO's delta. In consequence, the initial implied call option, which the creditor is short, should be more accurately priced. Thus rising rates will lead to a reduction in the creditor's short call option delta, and an increase in his long RPO delta.

One example of a RAM might have the following characteristics:
the debtor and creditor enter into a mortgage loan agreement in the amount of $250,000 for 30 years; with the documentation for the mortgage being substantially similar to a standard agreement except for financial details;
the mortgage requires the debtor to pay a fixed rate of interest, for example, 5%;
embedded within the mortgage is an RPO sold by the debtor to the creditor; and
the details of the RPO are as follows:
   by assumption, a strike rate of 8% is set—the strike rate is 300 bps above the initial or at-inception contract rate;
   by assumption, the volatility of the underlying rate-process, 30-year mortgage rates, is set at 12% per annum;
   by assumption, prepayments will occur on the mortgage at a rate determined by a prepayment model (which is known to skilled artisans) that may impound or be reflective of, inter alia, the following regression factors:
      the 30-year mortgage rate;
      the coupon of the underlying mortgage; and
      the age of the underlying mortgage.

As an example, a RAM with the above characteristics may have the following values:

| Descriptor | Value | Explanation/Description |
|---|---|---|
| Corresponding Spread | 16.3 bps | Annualized RPO Cost: in bps of original principal |
| Option Value | $12,531 | Present Value of 16.3 bps (annualized over original |
| | | nominal loan term) |
| Loan Amount | <$250,000> | Amount Borrowed |
| Current Rate | 5.00% | Assumed Initial Contract Rate |
| Strike Rate | 8.00% | Level at which RPO is exercisable |
| Annual Volatility of | 12.00% | Assumed annual rate movement |
| Rates | | |
| Term | 30 years | Original or nominal contract term: (i.e., before |
| | | prepayments and repayments and adjustments) |
| Frequency | 12 | Frequency of mortgage payments is monthly |
| New Principal Amount | <$182,899.82> | Principal subsequent to exercise of option, and |
| | | subsequent to principal adjustment |
| Prepayment Life | 14.45224 | Remaining nominal tenor, in years, of remaining |
| | | loan principal given prepayment model assumptions |
| Monthly Payment | <$1,342.00> | Amount of monthly mortgage payments, both |
| | | before and after option exercise (under this variant |
| | | of the RAM product) |

In this example:
Corresponding Spread, approximately 16.3 basis points (1 basis point=0.01%), is the annualized option cost;
Option Value (in dollars)=(Loan Amount) * (Corresponding Spread) * (Term);
the actual option value is the cumulative loss that the option writer may expect (based upon conditional exercise and conditional prepayment) to experience over the life of the loan, as originally calculated via applicant's pricing model, and is equivalent to, roughly, 5.0124% of the original principal, or ($250,000*0.050124)=$12,531;
Prepay Life, under the model assumptions, is no longer the original nominal 30 years, but 14.45 years; and
New Principal Amount is <$182,899>.

The result of the above transaction is as follows:
the debtor, at inception, owes <$250,000> principal plus the interest on the amortizing principal payable over a nominal 30 year life;
the debtor owns an implicit long call option that allows the debtor to exit the contract in the event that rates decline; and
the debtor, in addition to standard features above, sells to the creditor an RPO, which is 300 bps out of the money at inception.

Upon option exercise by the creditor the following occurs:
when mortgage rates are 300 bps or more above the initial contract rate, creditor exercises the long option, which causes the debtor to pay off the mortgage at the new contract rate of 8%;
Mortgage payments are held flat at the original monthly cash-flow level; and
in consideration for paying the remaining mortgage principal at a new contract rate of 8%, the creditor gives the debtor relief from a portion of the remaining underlying principal indebtedness.

Among the practically infinite possible permutations for structuring a RAM (or other instrument in accordance with the invention) that those of skill in the art will recognize are:
the types of option structures that may be used to create the RPO are practically infinite;
the prepayment model and its parameters may vary;
the debtor's ability to prepay after rate declines may or may not be limited under some structures;
the interest-rate-diffusion model used to calculate forward rates may be the Heath-Jarrow-Morton model, or may vary under a specific vendor's implementation of the RAM product (e.g., pure diffusion or jump diffusion);
the debt relief offered to the debtor can range from $0 to the entirety of the original loan principal (assuming no leverage);
the new contract rate to be charged may be 0% to infinity (mathematically speaking, the variations may be almost unlimited);
the resulting monthly payment amount may be unchanged or may vary;
the subject loan may be of any type (not just residential mortgage) and principal and interest payments—at inception, at the time of any interim adjustments, and at loan liquidation—may take any form (e.g., cash, in-kind, or shares);
the rate domain over which rational exercise is possible for the long option holder may be extended; and
the rate domain over which exercise may be considered to be irrational may be either reduced, or priced more fairly for both the long and short option holder.

Rate calculations may be performed with the Heath-Jarrow-Morton (“HJM”) model, which is a generalized term structure model. However, the model that is used may be diffusion, jump-diffusion, mixed diffusion, or any other vendor implementation of a generalized term-structure model.

With regard to computer-based systems that may embody or that may be used with embodiments of the invention (including the RAM), skilled artisans will recognize that given the state of the art in personal computing relative to microprocessor speed, software, and architecture, the pricing and implementation of the present invention, may be implemented on what is commonly referred to as a personal or home computer. In one preferred embodiment of the invention, the implementation of the invention in a financial institution context, it is anticipated that a valuation of a portfolio (more than one position) comprising multiple instances of the invention, especially with regard to term structure modeling, would require significant computing power. In such a preferred embodiment, while the software algorithms used for such valuation would not differ in form from that implemented on a personal computer, the computer used for such valuations preferably should be of the commercial or mainframe type, possessing correspondingly greater computational power, and possessing correspondingly greater storage capabilities. As skilled artisans will appreciate, systems that may embody or may be used with the present invention may be implemented with a wide variety of processors, storage devices, and associated hardware and software.

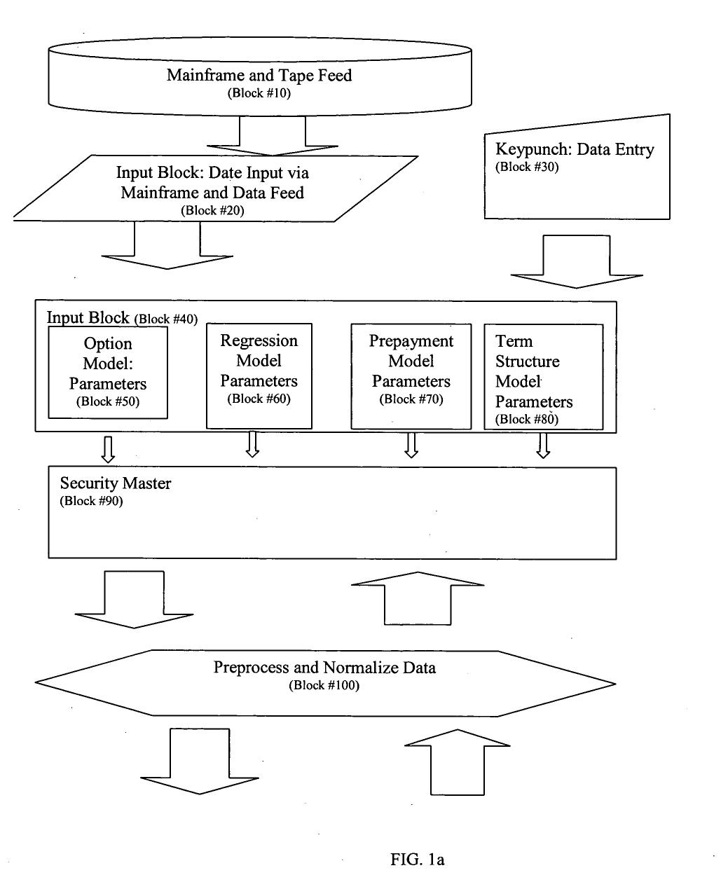

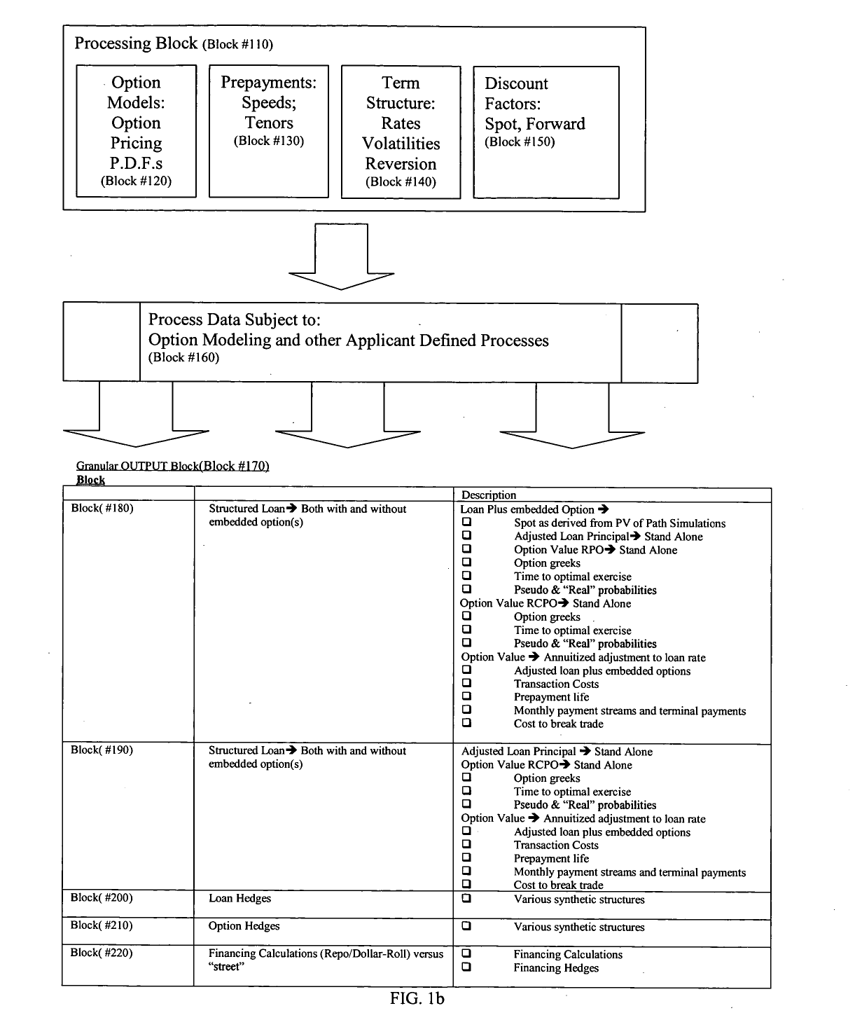

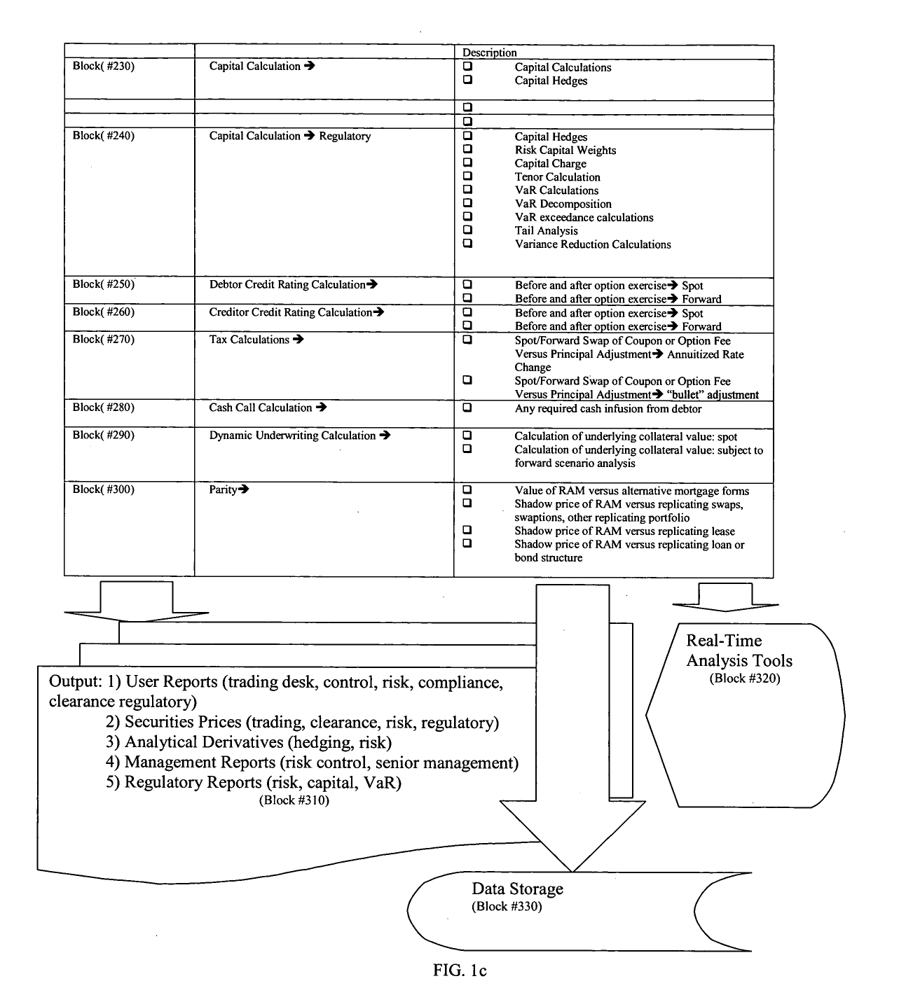

FIG. 1 shows a flowchart of one example of software that may be used in a system that provides a RAM product. As shown in FIG. 1a, both vendor (possibly tape fed) and keypunch data are gathered into mainframe storage in blocks #10-#30. Likewise, block #40, with sub-blocks #50-#80, is used to gather model parameters for the prepayment, regression, term-structure and option models. These parameters are gathered and stored in the security master (block #90). The security master preferably summarizes and stores: mainframe data; data feeds from vendors; keypunch data; security-indicative data; and pre-calculated values for interpolations and surfaces. The security master also preferably contains static security descriptors. Block #100, is the preprocessing module, which block is used to normalize data formats and convert units of measure to be used in the processing block. As shown in FIG. 1b, block #110, including sub-blocks #120-#150, is the location used for calculating inputs into the RAM applicant's pricing model, inter alia: volatilities, discount factors to be applied to cashflows, prepayment speeds. Block #160 is the core of the processing mechanism. In Block #160, the RAM applicant's model for pricing option-embedded loans and the related sensitivities are calculated. As shown in FIGS. 1b-1c, output block #170, with sub-blocks #180-#300, contains all the data that is to be used by a user of the invention, such as a broker, in order to price securities and derive any related sensitivities for the purposes of hedging or risk management. As shown in FIG. 1c, output blocks #310-#330 are used by those implementing the invention to gather, analyze, and store pertinent security information. The information in these blocks is used for pricing, hedging, management reporting, risk reporting, and regulatory reporting.

### Embedding the RPO in Interest-Bearing Borrowings (Another Embodiment)

Another embodiment of the invention uses a conventional interest bearing borrowing that is written at the current or the spot market level of interest. By market convention (rather than through an explicitly documented right), the borrowing may be retired by the debtor at any time: it is callable. In this embodiment, embedded in the instrument is the additional right of the debtor to sell a put option on a market interest rate—an RPO—to the creditor. The RPO sold by the debtor to the creditor may be an interest rate different from that which existed at the date of issuance as well as, potentially, the sale of a put on the entire term structure of interest rates for the appropriate market(s).

In this embodiment, the resulting “package” consists of:
the sale by the debtor to the creditor of a mortgage or other evidence of borrowing in exchange for cash;
the sale by the creditor to debtor of a call option to repay the borrowing early relative to the original nominal maturity;
the sale by debtor to the creditor of a put option on the market interest rate, as well as, potentially, the entire forward term structure of interest rates for the appropriate market(s) (the RPO); and
upon sale, the debtor receives the value of the RPO (which could be a one-time payment or an annuitized change to his borrowing rate, among other possibilities) as well as the right to have his principal borrowing correlatively adjusted to reflect his absorption of the new current (as well as, possibly, forward) levels of market interest rates.

The value of this above package may be dynamically calculated (at both spot and forward times) such that:
the debtor pays an initial stated level of interest to the creditor;
the debtor has the option to retire the borrowing, in whole or in part, at any time;
the debtor sells to the creditor an RPO which may cause the debtor to pay, in the future, an interest rate which may be higher than the interest payable at the instrument's inception;
in consideration of the RPO sold to the creditor, the debtor receives an adjustment to the principal of his borrowing. As noted above, this adjustment is more calculationally sophisticated than a simple rate-spread mark to market;

In this embodiment, the interest-bearing instrument is implemented via explicit permutations in the embedded option structure relative to:
the remaining nominal tenor,
the remaining nominal principal,
the principal and interest payments, and
the interest level imposed by the original obligation.

Adjustments to parameters used to model the RPO may include:
forward term structures of interest rates;
forward prepayments;
forward option prices; and
forward collateral prices.

In this embodiment, among the options available to implement the interest-bearing instrument are:
the calculation of the value of the options package attached to the borrowing may start at contract inception, or in the future (spot or forward starting options);
the options package may consist of options that may be exercised on a daily basis, or on the basis of any other temporal calculation; exercise dates may be:
   American (continuously exercisable);
   European (exercisable at maturity only);
   Bermudan (exercisable at selected interim dates between inception and maturity); or
   any combination of the above;
the options package may calculate interest implementation levels on either a discrete or continuous basis (strike prices may be continuous, discrete, or averaged);
option exercise may be based on hitting: a prescribed strike level, a barrier level or range created by multiple barrier levels, a spread indicative of over- or under-performance relative to a single instrument, or a basket of instruments;
the “knock-in” of certain option components may “knock-out” certain other related option components;
the “knock-out” of certain option components may “knock-in” certain other related option components;
the nature of the option may entail the calculation of a payout envelope created by the exchange of one asset exchanged for another;
options may be exercised by the holder through a “shout” where the holder declares the holder's desire to fix a strike or exercise level, or the maximum or minimum of a state-variable (whether a model input or model output) based upon the holder's best estimation of the possible evolution of the forward state-variable processes relative to the historical evolution of those processes over the already expired life;
exercise of options may be on a fixed, floating, or average strike;
option payout structures may be linear or non-linear, annuitized or lump-sum, paid at spot or deferred in settlement, paid in dollars, in foreign currency, or in-kind;
for any or all of the above calculations, the calculation may be done in any mathematical basis selected by either party to the transaction;
the option structure may be formed by a linear, or non-linear aggregation of the foregoing options; or by any other portfolio combination or basket of any of the foregoing variants of option; or through synthetic replication; and
option volatility, as well as other parametric inputs into
   the option model,
   the rate diffusion process,
   the prepayment model, or
   any other calculational building block,
may be stated on any basis of compounding or tenor, and may be calculated with any model, including, but not limited to: any generalized term structure or multi-factor model, ARCH, GARCH, IGARCH, or EGARCH.

For any system or method according to the present invention, pricing and capturing the value of a financial entities' regulatory capital savings is done using the following equation:

$${RCS}_{t} = ( {\sum }_{i = 1}^{i = T} ( ( {( {L}_{{u}_{a}} - {L}_{R} )}_{i} * RCW * RCP * {R}_{{k}_{i}} / F ) * {( 1 + {\overline{R}}_{{f}_{i}} / F )}^{- i} / {L}_{{u}_{{a}_{i}}} ) ) * 10000 \qquad ( 10 )$$

where:

| Symbol | Interpretation | Exemplary Value |
|---|---|---|
| RCS | Risk Capital Savings | Output |
| Lᵤₐ | Unamortized Loan Balance: Monthly | Amortized Loan |
| L_{R} | Unamortized Loan Balance: RAM | Variable: amortizes and |
| | variant (contains RPO or rate put | impacted by option |
| | option) | |
| RCW | Risk Capital Weight | 50% of notional by |
| | | assumption |
| RCP | Risk Capital Percentage | 8% capital set-aside by |
| | | assumption |
| Rₖ | Contract Rate Discount Factor | 5% by assumption |
| \overline{R}_{f}ₜ | Strike Rate Discount Factor | 8% by assumption |
| F | Periodicity | 12/yr or monthly |
| Lᵤₐ | Unamortized Loan Balance: Monthly | Amortized Loan |

Those skilled in the art will recognize that the foregoing embodiments and examples are only suggestive of, and do not limit, the possible underlying building blocks for an embodiment of the invention. As to any possible structure in accordance with the present invention, what is most preferable is that:
the borrowing be structured so that its sensitivity to, inter alia, interest rate changes, volatility changes, prepayment parameter or other model changes, allow the debtor and creditor to agree upon any possible combination or permutation of principal and interest to be paid, and the timing thereof;
the borrowing be structured so that the extension risk and credit risk typically found in borrowings that carry off-market coupons in a changing rate environment be completely subject to the creditor's and debtor's control; and
any implied options in the subject market be made explicit, be priced, and be used to control the rate, principal size, payment timing of the underlying obligation, and/or any other relevant parameter of the instrument so constructed;
any explicit options be priced under conditions of parity relative to any implied options; and
any implicit options be priced under conditions of parity relative to any explicit options.

A nonexclusive list of financial instruments that may be implemented using the present invention is as follows:
mortgages, including residential (such as for a house, condominium, cooperative unit, or any domicile regardless of form) and commercial (such as government-sponsored enterprise (GSE) loans (where the government may be federal, state, municipal, foreign, or otherwise, and where the GSE may a supranational agency such as the World Bank or other entities sponsored in whole or in part by one or more governments), mixed use, education loans, educational institution offering or a subset thereof, land trust for conservation or public purposes, religious financing structure (where no interest may be stated explicitly), and personal equity lines of credit for any purpose);
automobile loans, including equipment or equipment trust certificates, obligations arising out of a restructuring or change of corporate control, shipping entities (such as naval vessels, aircraft, spacecraft, cars, trucks, and trains), Internet entities, general-purpose corporate loans, collateralized loan obligations/collateralized bond obligations (CLOs/CBOs) military equipment, and consumer finance for durable goods (such as refrigerators, televisions, audio or video equipment, etc.);
deferred payment contracts, such as insurance policies, whether one-time payment or annuitized; and
leases, leveraged or otherwise, for the purchase of any goods or services, including any of the goods, services, and instruments described herein.

In addition, financial instruments according to the invention may be for one-time payment or annuitized; may involve sale of the entire spot-forward and/or forward-forward curves; may include adjustment of any model parameter or calculational component described in this specification or apparent to skilled artisans; or may be constructed with any set of instruments that may be used to construct an instrument via parity.

The scope of the present invention is defined by the claims and is not to be limited by the specific embodiments and examples described in this specification. Various modifications of the invention in addition to those described will be apparent to those skilled in the art from the foregoing description and accompanying figures. Such modifications are intended to come within the scope of the claims.

1. A method for enabling market-based pricing of a financial instrument, comprising the steps of:
(a) a debtor selling to a creditor an instrument evidencing borrowing of a principal;
(b) the creditor selling to the debtor a call option to repay the principal, or a portion thereof, early relative to an original maturity time of the instrument;
(c) the debtor selling to the creditor a rate put option (RPO);
(d) the debtor receiving the value of the RPO as well as a right, if market-interest rates have changed and the debtor's call option has been exercised, to have the principal adjusted to reflect an absorption by the debtor of new market-interest rates;
(e) the debtor paying an initial stated level of interest to the creditor;
(f) the creditor giving the debtor the option to retire any amount of the principal at any time;
(g) the debtor selling to the creditor a right to cause the debtor to pay, in the future, a different interest rate from an interest rate payable at a time of inception of the instrument; and
(h) if the creditor exercises the right to cause the debtor to pay the different interest rate, the debtor receiving an adjustment to the principal.

2. The method of claim 1, wherein the instrument evidencing borrowing is a mortgage.

3. The method of claim 2, wherein the mortgage is a residential mortgage.

4. The method of claim 2, wherein the mortgage is a commercial real estate mortgage.

5. The method of claim 3, wherein the residential mortgage is for a house.

6. The method of claim 3, wherein the residential mortgage is for a condominium.

7. The method of claim 3, wherein the residential mortgage is for a cooperative unit.

8. The method of claim 3, wherein the residential mortgage is for a government-sponsored enterprise.

9. The method of claim 8, wherein the government is a federal government.

10. The method of claim 8, wherein the government is a state government.

11. The method of claim 8, wherein the government is a municipal government.

12. The method of claim 8, wherein the government is a foreign sovereign entity.

13. The method of claim 8, wherein the government-sponsored enterprise is a supranational agency.

14. The method of claim 4, wherein the commercial real estate mortgage is for a government-sponsored enterprise.

15. The method of claim 14, wherein the government is a federal government.

16. The method of claim 14, wherein the government is a state government.

17. The method of claim 14, wherein the government is a municipal government.

18. The method of claim 14, wherein the government is a foreign sovereign entity.

19. The method of claim 14, wherein the government-sponsored enterprise is a supranational agency.

20. The method of claim 4, wherein the commercial real estate mortgage is for a mixed-use loan.

21. The method of claim 4, wherein the commercial real estate mortgage is for a subset of an educational institutional offering.

22. The method of claim 4, wherein the commercial real estate mortgage is for a land trust for conservation purposes.

23. The method of claim 4, wherein the commercial real estate mortgage is for a land trust for public purposes.

24. The method of claim 4, wherein the commercial real estate mortgage is for a religious financial structure.

25. The method of claim 4, wherein the commercial real estate mortgage is for a personal equity line of credit.

26. The method of claim 4, wherein the commercial real estate mortgage is for an education loan.

27. The method of claim 1, wherein the instrument evidencing the borrowing is an automobile loan.

28. The method of claim 1, wherein the instrument evidencing the borrowing is-an equipment loan.

29. The method of claim 1, wherein the instrument evidencing the borrowing is an equipment trust certificate loan.

30. The method of claim 1, wherein the instrument evidencing the borrowing is an obligation arising out of a restructuring.

31. The method of claim 20, wherein the instrument evidencing the borrowing is an obligation arising out of a change of corporate control.

32. The method of claim 20, wherein the instrument evidencing the borrowing is a loan is for a shipping entity.

33. The method of claim 25, wherein the shipping entity is a navel vessel.

34. The method of claim 25, wherein the shipping entity is an aircraft.

35. The method of claim 25, wherein the shipping entity is a spacecraft.

36. The method of claim 25, wherein the shipping entity is a car.

37. The method of claim 25, wherein the shipping entity is a truck.

38. The method of claim 25, wherein the shipping entity is a train.

39. The method of claim 1, wherein the instrument evidencing the borrowing is a loan for an Internet entity.

40. The method of claim 1, wherein the instrument evidencing the borrowing is a general purpose corporate loan.

41. The method of claim 1, wherein the instrument evidencing the borrowing is a collateralized loan obligation.

42. The method of claim 1, wherein the instrument evidencing the borrowing is a collateralized bond obligation.

43. The method of claim 1, wherein the instrument evidencing the borrowing is a military equipment loan.

44. The method of claim 1, wherein the instrument evidencing the borrowing is a consumer financing for durable goods.

45. The method of claim 1, wherein the instrument evidencing the borrowing is a lease.

46. The method of claim 45, wherein the lease is leveraged.

47. The method of claim 1, wherein the value of the put is a one-time payment.

48. The method of claim 1, wherein the value of the put is an annuitized change to the debtor's borrowing rate.

49. The method of claim 1, wherein in step (c) the debtor further sells to the creditor the entire spot-forward curve, or the forward-forward curve, or a combination of the two.

50. A method for structuring an interest-bearing instrument in a subject market, the instrument having a debtor, a creditor, a sensitivity to parameter changes, an extension risk, a credit risk, and an underlying obligation having a principal size, an interest rate, and a payment timing, comprising the steps of:
(a) providing that the instrument's sensitivity to parameter changes allow a debtor and a creditor to agree upon any possible combination or permutation of principal and interest to be paid, and the timing thereof;
(b) providing that the instrument's extension risk and credit risk be completely subject to the creditor's and debtor's control through a calculation of an agreement upon interest rates; and
(c) providing that any options in the subject market may be made explicit, may be priced, and may be used to control the principal size, interest rate, and payment timing of the underlying obligation.

51. The method of claim 1, wherein pricing and capturing the value of a financial entities' regulatory capital savings is done using the following equation:
$${RCS}_{t} = ( {\sum }_{i = 1}^{i = T} ( ( {( {L}_{{u}_{a}} - {L}_{R} )}_{i} * RCW * RCP * {R}_{{k}_{i}} / F ) * {( 1 + {\overline{R}}_{{f}_{i}} / F )}^{- i} / {L}_{{u}_{{a}_{i}}} ) ) * 10000$$
where:
RCS is Risk Capital Savings;
Lᵤₐ is Unamortized Loan Balance: Monthly;
L_{R} is Loan: RAM variant (contains rate put option);
RCW is Risk Capital Weight;
RCP is Risk Capital Percentage;
Rₖ is Contract Rate Discount Factor;
\overline{R}_{f}_{ₜ} is Strike Rate Discount Factor; and
F is Periodicity.

52. The method of claim 50, wherein pricing and capturing the value of a financial entities' regulatory capital savings is done using the following equation:
$${RCS}_{t} = ( {\sum }_{i = 1}^{i = T} ( ( {( {L}_{{u}_{a}} - {L}_{R} )}_{i} * RCW * RCP * {R}_{{k}_{i}} / F ) * {( 1 + {\overline{R}}_{{f}_{i}} / F )}^{- i} / {L}_{{u}_{{a}_{i}}} ) ) * 10000$$
where:
RCS is Risk Capital Savings;
Lᵤₐ is Unamortized Loan Balance: Monthly;
L_{R} Loan: RAM variant (contains rate put option);
RCW is Risk Capital Weight;
RCP Risk Capital Percentage;
Rₖ is Contract Rate Discount Factor;
\overline{R}_{f}_{ₜ} is Strike Rate Discount Factor; and
F is Periodicity.

53. A computer-based system for structuring an interest-bearing instrument, comprising:
(a) means for adding to a borrowing a rate put option on an interest rate of the borrowing; and
(b) means for permitting correlative adjustments to an outstanding loan principal of the borrowing.

54. A method for structuring an interest-bearing instrument, comprising:
(a) adding to a borrowing a rate put option on an interest rate of the borrowing; and
(b) permitting correlative adjustments to an outstanding loan principal of the borrowing.

55. A computer-based method for structuring an interest-bearing instrument, comprising:
(a) adding to a borrowing a rate put option on an interest rate of the borrowing; and
(b) permitting correlative adjustments to an outstanding loan principal of the borrowing.

56. A computer-based system for enabling market-based pricing of a financial instrument, comprising:
(a) means for processing data regarding a debtor selling to a creditor an instrument evidencing borrowing of a principal;
(b) means for processing data regarding the creditor selling to the debtor a call option to repay the principal, or a portion thereof, early relative to an original maturity time of the instrument;
(c) means for processing data regarding the debtor selling to the creditor a rate put option (RPO);
(d) means for processing data regarding the debtor receiving the value of the RPO as well as a right, if market-interest rates have changed and the debtor's call option has been exercised, to have the principal adjusted to reflect an absorption by the debtor of new market-interest rates;
(e) means for processing data regarding the debtor paying an initial stated level of interest to the creditor;
(f) means for processing data regarding the creditor giving the debtor the option to retire any amount of the principal at any time;
(g) means for processing data regarding the debtor selling to the creditor a right to cause the debtor to pay, in the future, a different interest rate from an interest rate payable at a time of inception of the instrument; and
(h) means for processing data regarding the debtor receiving an adjustment to the principal, if the creditor exercises the right to cause the debtor to pay the different interest rate.

57. The system of claim 56, wherein the instrument evidencing borrowing is a mortgage.

58. The system of claim 57, wherein the mortgage is a residential mortgage.

59. The system of claim 57, wherein the mortgage is a commercial real estate mortgage.

60. The system of claim 58, wherein the residential mortgage is for a house.

61. The system of claim 58, wherein the residential mortgage is for a condominium.

62. The system of claim 58, wherein the residential mortgage is for a cooperative unit.

63. The system of claim 58, wherein the residential mortgage is for a government-sponsored enterprise.

64. The system of claim 63, wherein the government is a federal government.

65. The system of claim 63, wherein the government is a state government.

66. The system of claim 63, wherein the government is a municipal government.

67. The system of claim 63, wherein the government is a foreign sovereign entity.

68. The system of claim 63, wherein the government-sponsored enterprise is a supranational agency.

69. The system of claim 59, wherein the commercial real estate mortgage is for a government-sponsored enterprise.

70. The system of claim 69, wherein the government is a federal government.

71. The system of claim 69, wherein the government is a state government.

72. The system of claim 69, wherein the government is a municipal government.

73. The system of claim 69, wherein the government is a foreign sovereign entity.

74. The system of claim 69, wherein the government-sponsored enterprise is a supranational agency.

75. The system of claim 59, wherein the commercial real estate mortgage is for a mixed-use loan.

76. The system of claim 59, wherein the commercial real estate mortgage is for a subset of an educational institutional offering.

77. The system of claim 59, wherein the commercial real estate mortgage is for a land trust for conservation purposes.

78. The system of claim 59, wherein the commercial real estate mortgage is for a land trust for public purposes.

79. The system of claim 59, wherein the commercial real estate mortgage is for a religious financial structure.

80. The system of claim 59, wherein the commercial real estate mortgage is for a personal equity line of credit.

81. The system of claim 59, wherein the commercial real estate mortgage is for an education loan.

82. The system of claim 56, wherein the instrument evidencing the borrowing is an automobile loan.

83. The system of claim 56, wherein the instrument evidencing the borrowing is an equipment loan.

84. The system of claim 56, wherein the instrument evidencing the borrowing is an equipment trust certificate loan.

85. The system of claim 56, wherein the instrument evidencing the borrowing is an obligation arising out of a restructuring.

86. The system of claim 75, wherein the instrument evidencing the borrowing is an obligation arising out of a change of corporate control.

87. The system of claim 75, wherein the instrument evidencing the borrowing is a loan is for a shipping entity.

88. The system of claim 87, wherein the shipping entity is a navel vessel.

89. The system of claim 87, wherein the shipping entity is an aircraft.

90. The system of claim 87, wherein the shipping entity is a spacecraft.

91. The system of claim 87, wherein the shipping entity is a car.

92. The system of claim 87, wherein the shipping entity is a truck.

93. The system of claim 87, wherein the shipping entity is a train.

94. The system of claim 56, wherein the instrument evidencing the borrowing is a loan for an Internet entity.

95. The system of claim 56, wherein the instrument evidencing the borrowing is a general purpose corporate loan.

96. The system of claim 56, wherein the instrument evidencing the borrowing is a collateralized loan obligation.

97. The system of claim 56, wherein the instrument evidencing the borrowing is a collateralized bond obligation.

98. The system of claim 56, wherein the instrument evidencing the borrowing is a military equipment loan.

99. The system of claim 56, wherein the instrument evidencing the borrowing is a consumer financing for durable goods.

100. The system of claim 56, wherein the instrument evidencing the borrowing is a lease.

101. The system of claim 100, wherein the lease is leveraged.

102. The system of claim 56, wherein the value of the put is a one-time payment.

103. The system of claim 56, wherein the value of the put is an annuitized change to the debtor's borrowing rate.

104. The system of claim 56, wherein the means in element (c) further includes means for processing data regarding the debtor to sell to the creditor the entire spot-forward curve, or the forward-forward curve, or a combination of the two.

105. A computer-based system for structuring an interest-bearing instrument in a subject market, the instrument having a debtor, a creditor, a sensitivity to parameter changes, an extension risk, a credit risk, and an underlying obligation having a principal size, an interest rate, and a payment timing, comprising:
(a) means for providing that the instrument's sensitivity to parameter changes allow a debtor and a creditor to agree upon any possible combination or permutation of principal and interest to be paid, and the timing thereof;
(b) means for providing that the instrument's extension risk and credit risk be completely subject to the creditor's and debtor's control through a calculation of an agreement upon interest rates; and
(c) means for providing that any options in the subject market may be made explicit, may be priced, and may be used to control the principal size, interest rate, and payment timing of the underlying obligation.

106. The system of claim 56, wherein pricing and capturing the value of a financial entities' regulatory capital savings is done using the following equation:
$${RCS}_{t} = ( {\sum }_{i = 1}^{i = T} ( ( {( {L}_{{u}_{a}} - {L}_{R} )}_{i} * RCW * RCP * {R}_{{k}_{i}} / F ) * {( 1 + {\overline{R}}_{{f}_{i}} / F )}^{- i} / {L}_{{u}_{{a}_{i}}} ) ) * 10000$$
where:
RCS is Risk Capital Savings;
Lᵤₐ is Unamortized Loan Balance: Monthly;
L_{R} is Loan: RAM variant (contains rate put option);
RCW is Risk Capital Weight;
RCP is Risk Capital Percentage;
Rₖ is Contract Rate Discount Factor;
\overline{R}_{f}_{ₜ} is Strike Rate Discount Factor; and
F is Periodicity.

107. The system of claim 105, wherein pricing and capturing the value of a financial entities' regulatory capital savings is done using the following equation:
$${RCS}_{t} = ( {\sum }_{i = 1}^{i = T} ( ( {( {L}_{{u}_{a}} - {L}_{R} )}_{i} * RCW * RCP * {R}_{{k}_{i}} / F ) * {( 1 + {\overline{R}}_{{f}_{i}} / F )}^{- i} / {L}_{{u}_{{a}_{i}}} ) ) * 10000$$
where:
RCS is Risk Capital Savings;
Lᵤₐ is Unamortized Loan Balance: Monthly;
L_{R} Loan: RAM variant (contains rate put option);
RCW is Risk Capital Weight;
RCP Risk Capital Percentage;
Rₖ is Contract Rate Discount Factor;
\overline{R}_{f}_{ₜ} is Strike Rate Discount Factor; and
F is Periodicity.
